(19) United States
(12) Patent Application Publication
(10) Pub. No.: US 2014/0278890 A1
(43) Pub. Date: Sep. 18, 2014

(54) SYSTEM AND METHOD FOR MANAGING REWARD PROGRAMS

(71) Applicant: AIRPOINTS, INC., Little Rock, AR (US)

(72) Inventors: Jeff Ford, Little Rock, AR (US); Chuck Foster, Littlte Rock, AR (US); Shari Marion-Hoff, Renton, WA (US)

(73) Assignee: AIRPOINTS, INC., Little Rock, AR (US)

(21) Appl. No.: 14/213,107

(22) Filed: Mar. 14, 2014

Related U.S. Application Data
(60) Provisional application No. 61/790,437, filed on Mar. 15, 2013.

(51) Int. Cl. G06Q 30/02

(52) U.S. Cl. CPC G06Q 30/0226
USPC 705/14.27

(57) ABSTRACT

An Internet-based incentive/rewards platform designed to serve the needs of the indirect channel is provided to independent business partners by industry manufacturers. Through the platform, participating channel partners can review details, e.g., the terms and conditions, of prospective promotions/contests or reward programs offered by manufacturers and can accept or decline the offers to participate in the manufacturer-provided programs. Once the channel partner accepts the manufacturer-provided promotion/contest or reward program, the partner may modify or append certain elements of the program to better fit the partner's business processes and compensation plans. The platform provides administrative tools to track and report participant progress through a claims submittal process where internal partner personnel earn rewards. Rewards can be redeemed for items in an integrated rewards catalog.

### CROSS REFERENCE TO RELATED APPLICATIONS

This application claims the benefit of U.S. Provisional Application No. 61/790,437, filed Mar. 15, 2013, entitled PARTNER EXPERIENCE EXTENDER, which Application is incorporated by reference herein in its entirety.

### BACKGROUND

The present application relates generally to reward programs. More specifically, the present application relates to a platform that permits independent companies to participate in and modify reward programs or promotions from multiple manufacturers, while also being able to generate their own reward programs or promotions.

Manufacturers (and/or vendors) often engage “partners,” e.g., independent companies not affiliated with the manufacturer, to assist with the promotion and/or sale of the products and/or services offered by the manufacturer. The manufacturer's use of partners can be characterized as an “indirect channel” since there is no affiliation or connection between the partner (or its employees) and the manufacturer. The manufacturer's use of its own employees for promotion and sales can be characterized as a “direct channel” since the employees work for the manufacturer.

Independent companies may work or partner with an average of 6-25 different manufacturers at any given time. If a manufacturer wants to increase the promotion and/or sales of its products and/or services, the manufacturer may offer a reward or incentive program to its partners to motivate the partners to increase their promotion and/or sales of the manufacturer's products and/or services. Traditional manufacturer reward programs place the manufacturer in control of how the reward program is structured and offered to the partners. One common reward program for partners includes the accumulation and redemption of reward points at the organization or representative level for the completion of certain actions or activities that are designated by the manufacturer.

In addition to controlling the terms and conditions of the reward program, the manufacturer's reward program may be provided to the partners on a proprietary platform or tool. Each manufacturer's use of a proprietary platform can result in a plethora of different platforms that companies have to use and navigate if they are working with multiple manufacturers. Navigating and using multiple platforms adds to the administrative burden of the companies that participate in manufacturer-provided programs.

The partner's decision to participate in a manufacturer's reward program can be based on several factors including how well the reward program fits or matches the business processes and compensation models of the partner and the method of communication of the available programs to the partner, i.e., the partner cannot participate in programs for which they did not receive notice.

Therefore, what is needed is a system and method for managing reward programs or promotions that permits independent companies to easily learn about, participate in and modify, as needed, multiple manufacturer reward or incentive programs.

### SUMMARY

One embodiment of the present invention is directed to a computer implemented method of managing rewards associated with a plurality of promotions. The method includes creating a promotion by a manufacturer using a computer-based platform. The promotion has at least one activity to be completed to receive a reward. The method also includes sending an invitation over a computer network to at least one partner to participate in the created promotion using the computer-based platform. The at least one partner is not affiliated with the manufacturer creating the promotion. The method includes accepting the invitation to participate in the created promotion by the at least one partner using the computer-based platform, modifying the accepted promotion by the at least one partner using the computer-based platform to add at least one additional activity or at least one additional reward, and selecting, by the at least one partner, at least one participant to participate in the modified promotion using the computer-based platform. The method further includes completing, by the selected at least one participant, at least one activity associated with the modified promotion, entering information on the completed at least one activity into the computer-based platform by the selected at least one participant, providing the reward to the selected at least one participant using the computer-based platform in response to the selected at least one participant entering the information on the completed at least one activity, and redeeming an item from an integrated catalog, by the selected at least one participant, with the provided reward using the computer-based platform.

Another embodiment of the present invention is directed to a system to manage rewards associated with a plurality of promotions. The system includes a first computing device, a second computing device, a third computing device and a fourth computing device. The first computing device includes a memory device to store a rewards platform and a microprocessor to execute the rewards platform. The second computing device is operated by a manufacturer and communicates with the first computing device over the computer network. The manufacturer accesses the rewards platform on the first computing device to create a reward program. The reward program has at least one activity to be completed and a reward to be provided upon completion of the at least one activity. The third computing device is operated by a partner. The third computing device communicates with the first computing device over the computer network. The partner receives an invitation from the reward program on the third computing device to participate in the created rewards program from the manufacturer and accesses the rewards platform on the first computing device with the third computing device to accept the invitation to participate in the created rewards program. The fourth computing device is operated by a participant and communicates with the first computing device over the computer network. The participant receives an invitation from the reward program on the fourth computing device to participate in the accepted rewards program by the partner and accesses the rewards platform on the first computing device with the fourth computing device to accept the invitation to participate in the accepted rewards program.

In one exemplary embodiment, computer-implemented systems and methods are used to provide and encourage the use of an Internet-based incentive or rewards platform. The Internet-based incentive or rewards platform is extended or provided to independent business partners by industry manufacturers to serve the needs of the indirect channel. Through the platform, participating indirect channel partners can review details of prospective promotions or contests offered by the manufacturer and accept or decline the terms and conditions to participate in the manufacturer-provided promotion or contest. Once the indirect channel partner accepts the terms and conditions of the manufacturer-provided promotion or contest, the partner may modify or append certain elements of the promotion or contest to better fit the partner's business processes and compensation plans. Elements of the reward program may include or be related to, but are not limited to, product code (SKU) identifiers, reward point values, defined business activity, organization participation, team participation, individual representative participation, and rewards value. The platform can provide administrative tools to track and report participant progress through a claims submittal process where partners and/or internal partner personnel (or participants) earn reward points, which can be aggregated, from multiple manufacturers for the benefit of the participant. Reward points can be redeemed for rewards or items in an integrated rewards catalog. Partners may also utilize the platform independently of manufacturer-provided promotions or contests to recognize and reward their own internal personnel.

One advantage of the present application is that a partner may modify the manufacturer-provided programs to help recognize and reward internal personnel based on the partner's specific objectives.

Another advantage of the present application is that multiple manufacturer (and/or vendor) organizations can motivate partner performance on training, enablement, business opportunities, and sales.

Other features and advantages of the present application will be apparent from the following more detailed description of the described embodiments, taken in conjunction with the accompanying drawings which illustrate, by way of example, the principles of the application.

### BRIEF DESCRIPTION OF THE DRAWINGS

FIG. 1 schematically shows users of a rewards platform in an exemplary embodiment.

FIG. 2 schematically shows the interaction between the users and the rewards platform in an exemplary embodiment.

FIG. 3 shows an exemplary embodiment of a process for a partner to manage rewards for a promotion.

FIG. 4 shows an exemplary embodiment of a process for a manufacturer to manage rewards for a promotion.

FIG. 5 shows an exemplary embodiment of a process for a participant to redeem rewards.

FIG. 6 shows an exemplary embodiment of a manufacturer administrator's view or user interface provided by the platform.

FIG. 7 shows an exemplary embodiment of a partner administrator's view or user interface provided by the platform.

FIG. 8 shows an exemplary embodiment of an individual participant's view or user interface provided by the platform.

FIG. 9 shows an exemplary embodiment of a user interface provided by the platform for a participant to enter activity information.

FIG. 10 shows an exemplary embodiment of a user interface provided by the platform for a partner administrator to review completed activities by participants.

FIG. 11 shows an exemplary embodiment of a user interface provided by the platform for a participant to access the reward catalog.

FIG. 12 shows an exemplary embodiment of a user interface provided by the platform for a manufacturer administrator to generate reports.

FIG. 13 shows an exemplary embodiment of a registered users report generated by the platform.

FIG. 14 shows an exemplary embodiment of a redemptions by day report generated by the platform.

FIG. 15 shows an exemplary embodiment of a participant claim summary report generated by the platform.

Wherever possible, the same reference numbers will be used throughout the drawings to refer to the same or like parts.

### DETAILED DESCRIPTION OF THE EXEMPLARY EMBODIMENTS

The present application is directed to a network-based platform or system for creating, communicating and managing incentive and/or rewards programs or promotions for indirect channel partners by manufacturers (and/or vendors). The indirect channel partners for a manufacturer can include, but are not limited to, original equipment manufacturer's alliances, independent companies, independent contractors, independent distributors, system integrators, value added resellers and/or independent sales representatives who do not work for and are not affiliated with the manufacturer, but who are engaged by the manufacturer for the promotion (or advertising) and/or sale of the manufacturer's goods and/or services either as a stand-alone product or as an integrated element of a reseller's end product.

In an exemplary embodiment, the platform can include one or more computers and/or microprocessors executing one or more computer programs or software applications. The computer programs or software applications can be stored in one or more memory devices incorporated in the platform. The platform can include one or more modems, transceivers, network cards or any other suitable device to enable the platform to communicate with users over wired or wireless networks. The platform can include one or more user interfaces to permit users to interact with the platform and to enter and/or receive information from the platform. Users can access the platform with any suitable device that can connect to the network(s) used by the platform. User devices can include hand-held devices, e.g., smart-phones or tablet computers; portable devices, e.g., laptop computers; and “stationary” devices, e.g., desktop computers.

In an exemplary embodiment, the platform provides and encourages use of Internet-based incentive or rewards programs or promotions extended to independent business partners by industry manufacturers to serve the needs of the indirect channel. In one embodiment, the indirect channel refers to audiences that are not directly employed by the manufacturer sponsor of a contest or program, but instead are third party companies that are essentially used as outsourced resellers (e.g., sales representatives). The platform can enable participating indirect channel partners to review details of prospective promotions or contests offered by the manufacturer and to accept or decline the terms and conditions of the offer to participate in the manufacturer-provided promotion.

Once the indirect channel partner accepts the terms and conditions of the manufacturer-provided promotion, program or contest, the partner may modify or append certain elements of the program to better fit the partner's business processes and compensation plans. Elements of a manufacturer-provided program may include or be related to, but are not limited to, aspects associated with product codes (SKUs) for the sale of products, reward point values, defined business activities, organization participation, team participation, individual representative participation, and reward values, such as specific items or monetary amounts. In one embodiment, a modified total reward value that includes an incremental reward value provided by the partner along with the reward value provided by the manufacturer(s) can be used. The value of the rewards can be represented with the label “rewards points,” but the points can have an actual monetary value as specified by the platform or in the original manufacturer program.

The platform provides administrative tools to track and report participant progress through a claims submittal or submission process where partners and/or participants (e.g., internal partner personnel) earn rewards (or points) from multiple manufacturers, which rewards (or points) can then be aggregated for personal benefit. Rewards (or points) can be redeemed for items in an integrated rewards catalog that includes all manufacturers' rewards. In one embodiment, the platform can have a fixed currency value of rewards points related to a monetary currency value, e.g., $1=100 points. In another embodiment, the manufacturer can set the relationship of currency value to reward points for the manufacturer's programs. Each manufacturer can determine the value of the reward for the achievement of a specified action or activity and represent that value in points. The value of individual actions can vary by manufacturer, but all earned reward points can be aggregated in the personal account of a partner participant, e.g., sales representative, and used for the redemption of rewards from a rewards catalog that is common to all participants and to all manufacturers. Through the platform, partners may utilize the tool independently of manufacturer-provided promotions or contests to recognize and reward internal partner personnel.

In an exemplary embodiment, the platform or system also permits a partner to edit or modify the terms and conditions of a manufacturer's rewards program or promotion to better serve the business objectives of the partner. The partner can also create, communicate and manage its own rewards program or promotion for its employees using the platform that is in addition to any manufacturer rewards programs or promotions being participated in by the partner.

FIG. 1 shows an arrangement of users of the platform in one exemplary embodiment. Each manufacturer 102 may offer a rewards program or promotion, using the rewards platform or system, to one or more partners 104 associated with the partner's sale and/or promotion of the manufacturer's goods and/or services. An individual partner 104 may work with one or more manufacturers and participate in rewards programs or promotions offered by several manufacturers 102, using the rewards platform or system. The use of the platform enables the partners 104 to access each of the rewards programs or promotions being offered by the manufacturers 102 at a central or single location (or access point). Each partner 104 that decides to participate in a manufacturer's rewards program can select one or more employees or participants 106 to participate in the rewards program. Each participant 106 in a manufacturer's rewards program can have access to the platform to learn about the rewards program(s) and monitor the participant's progress in each reward program. In another embodiment, the partner 104 may decide to form one or more teams 108 of participants 106 to participate in the rewards program. Each participant 106 of a team 108 participating in a manufacturer's reward program can have access to the platform to learn about the rewards program(s) and monitor the participant's and team's progress in each reward program or promotion.

FIG. 2 shows the interaction between the users and the platform in one exemplary embodiment. The manufacturers 102, partners 104 and participants 106 can all access the rewards platform or system 200 over a computer network 202. The computer network 202 can be any suitable type of computer network(s) that enables the users to access, communicate and/or exchange information with the platform 200, such as the Internet, a wide area network (WAN), Intranet or a local area network (LAN). In addition, a platform administrator 204 can access the platform 200 either directly or over the network 202 to perform upgrades to the platform 200, set-up user accounts, and/or to provide routine maintenance to the platform 200.

In an exemplary embodiment, the platform administrator 204 can setup or create an account for a manufacturer 102 and a corresponding manufacturer administrator in the rewards platform 200. Depending on the authorizations and/or permissions provided to the manufacturer administrator, the manufacturer administrator can create other users or administrators for the manufacturer 102. A manufacturer administrator can then create accounts for one or more partners 104 and corresponding partner managers or administrators for each partner 104. In another embodiment, the platform administrator 204 can create an account for the partners 104 and partner managers. A partner manager can then identify and create accounts for each participant 106 associated with the partner 104. Each participant 106 can receive a notification (e.g., an email) with login information for the participant 106 to access the rewards platform 200. The participant 106 needs the login information to gain access to the rewards platform to participate in promotions and redeem earned rewards.

The rewards platform 200 can be used for creating, managing and communicating incentive or rewards programs or promotions to channel partners. In an exemplary embodiment, the rewards platform 200 can provide three administrative views for the management of the rewards programs or promotions. The three administrative views are: manufacturer administrator view, partner administrator view, and individual participant view. The manufacturer administrator view permits and enables manufacturer administrators or managers to manage promotions, partners, and rewards through the platform or system. The partner administrator view permits and enables partner administrators or managers to manage promotions, employees, and rewards through the platform or system.

As shown in FIG. 6, the manufacturer administrator's view or user interface 600 can provide access to dashboard reporting that presents top promotions (or programs) 602, top partners 604, and site activity results 606 to the reward program administrators or managers for the manufacturer. For example, the top promotion information can include information on the number of partners participating in a promotion relative to the number of partners invited, the number of points paid by the manufacturer for the promotion and the number of payouts to the participants; the top partner information can include number of promotions participated in by the partner, the number of participants in the promotions and the total points earned by the participants; and the site activity results information can include information on the number of logins by the participants over a predetermined period and the number of redemptions by the participants over a predetermined period.

The manufacturer administrator can drill-down or navigate through the manufacturer administrator's view 600 to obtain detailed reporting information provided by the dashboard as needed. In one embodiment, the manufacturer administrator can only obtain and view information on promotions that were created by the manufacturer and cannot view information on other promotions offered by other manufacturers even if the manufacturer's partner is a partner for the other promotion. Manufacturer administrators can create new promotions within the platform or system by performing one or more of the following actions: selecting from a variety of promotion banners; selecting or creating promotion terms and conditions; providing promotion start and end dates; allowing a grace period for promotion claims; providing a description of the promotion; defining the activities associated with the promotion; assigning rewards (or points) to required activities and transactions; selecting all or specific partners to be offered the promotion; determining region, type of partner, roles, and tier of partner; establishing the workflow order or process to approve the promotion; obtaining the workflow approvals for the promotion prior to promotion activation; and activating and pushing the promotion to selected partners through the platform or system.

FIG. 3 shows an exemplary embodiment of a process for a manufacturer to manage rewards for a promotion or reward program. The process begins with a manufacturer administrator creating a promotion for the manufacturer (step 302) using the platform. When creating the promotion or reward program with the platform, the manufacturer administrator can do one or more of the following: create or select (from predetermined options) a name for the promotion; provide a general description of the promotion; create or select (from predetermined options) the terms and conditions for the promotion that control how the promotion is executed and applied to participants; select the period of time that the promotion will be active or available, including the providing of start and end times and dates; create, pre-load or select (from predetermined options) a graphical banner 608 (see FIG. 6) to be associated with the promotion, e.g., an image from a digital file that advertises the promotion; determine if a grace period for promotion claims will be provided; define the activities, including base (required) activities and optional activities, associated with the promotion to be completed to earn rewards (or points); and assign rewards (or points) to those required and optional activities and transactions. When using the platform, the manufacturer administrator can manually enter information into the platform to provide information on the promotion or the manufacturer administrator can select a parameter for the promotion from one or more available preselected options provided by the platform. The available preselected options can be incorporated or stored in the platform and/or can be provided based on previous entries used for previous promotions.

After the manufacturer administrator has created the promotion, the manufacturer administrator can invite one or more partners to participate in the promotion or reward program (step 304). As part of the invitation process, the manufacturer administrator can: individually select specific partners to be offered the promotion either from a list of partners recognized by the platform or used by the manufacturer or by entering information into the platform on a new partner; select partners based on specific parameters including geographic regions, types of partners, roles, and tiers of partners; obtain workflow approvals of the promotion prior to promotion activation (this action could also be completed as part of the creation process); and activate and push the promotion to the selected partners through the platform or system. In another embodiment, the manufacturer administrator can send each partner manager to be invited to participate in the promotion an invitation sent by email or other digital communication technique that briefly explains the promotion and provides a link to accept the invitation. In one embodiment, the sending of the email and the acceptance of the invitation (through the link) can be completed by the platform. In a further exemplary embodiment, the emails to the partner managers can refer the partner managers to the platform for additional information on the promotion and an option to accept the invitation.

After the manufacturer administrator invites the partners to participate in the promotion or reward program, the partner manager can then decide to accept or decline the invitation. If the partner manager decides to decline the invitation and not participate in the promotion the process ends. If the partner manager finds the promotion to be acceptable, the partner manager can accept the promotion invitation (step 306). After the partner manager accepts the promotion, the partner manager has to decide on whether or not the partner will extend the manufacturer promotion for the partner's participants (step 308). If the partner decides to extend the promotion or reward program, the partner manager can then create additional promotion parameters for the partner's participants (step 310). The creation of additional promotion parameters by the partner manager can be completed in a manner similar to the creation of the promotion by the manufacturer administrator. For example, the partner manager can create additional activities worth additional rewards (or points) to be completed by the participants.

After the partner manager has created the additional promotion parameters, or if the promotion was not extended by the partner, the partner can select the participants to participate in the promotion (step 312). The participants can be group, team and/or individually based or selected. After the participants have been selected, a determination is made as to whether any teams (or groups) have been selected as participants (step 314). If any teams (or groups) have been selected, the rewards (or points) have to be assigned or distributed to the team members (step 316). The distribution of rewards (or points) to the team members can be: 1) distributed equally among team members; 2) can be provided to a team account that can be accessed by individuals (account signers) who have access to spend from the team account; or 3) manually assigned distribution percentages to individual team members.

After the partner manager has assigned or distributed the points to the team members, or if no teams were selected as participants, the participants or partner managers can submit completed activities for the promotion or reward program to the platform (step 318). The completed activities can be submitted by: user entry and reconciled; system integration techniques that include XML, SOAP, or JSON formats via REST, traditional POST/GET, SAML, SAML2, or OATH; or by flat file data feed techniques that include the following file types: CSV files, XML files, Excel files, tab-delimited files, semi-colon delimited files, and custom file formats and that can be transmitted via email, FTP, SFTP, file sharing solutions utilizing “cloud” technology, or uploaded through a hosted web form provided by the platform. As completed activities are submitted by participants, an optional determination can be made using the platform as to whether the completed activities have been approved (step 320). The approval process (step 320) is an optional step that is not required for all promotions or reward programs. If required, the approval process involves the manufacturer administrator and/or the partner manager making a determination that the submitted activity has been completed in the proper manner. In one embodiment, the originator of the activity can make the determination on whether the activity has been properly completed. However, in another embodiment the determination responsibility can be delegated, e.g., the manufacturer administrator can delegate approval responsibility to the partner manager. In still another embodiment, the platform itself can make the decision using a set of decision rules. If the activities are not approved, the process returns to step 318 to give the participants an opportunity to edit or reenter the information associated with the activity to see if it can be approved. In another embodiment, the participants cannot resubmit activity information and can only submit information on newly completed activities.

After the promotion activities are approved, or if no approval is required, the corresponding rewards (or points) are provided to the participants for the completed activities (step 322). The provided rewards can be “paid for” out of a manufacturer account for manufacturer-initiated activities and out of a partner account for partner initiated activities and partner additions to manufacturer-initiated activities. The distribution can be: to the individuals who made the completed activity submissions; in accordance with team distribution rules; or by the partner manager. In another embodiment, the process can return to step 318 to give the participants additional opportunities to submit completed activities for approval. In one embodiment, the approval and rewards distribution steps can be completed each time a completed activity is submitted by a participant. In another embodiment, the approval and reward distribution steps can be completed one time after all completed activities have been submitted by participants.

As shown in FIG. 7, the partner administrator's view or user interface 700 can provide the administrators or managers for each partner access to dashboard reporting that presents top promotions 702, top representatives or participants 704, site activity results 706 and top redeemed items (not shown). For example, the top promotion information can include information on the number of participants for the promotion, the total number of points paid for the promotion and the total number of points paid to the partner; the top participant information can include number of promotions participated in by the participant, the number of points earned by the participant, the number of redemptions by the participant and the total points redeemed by the participant, and the site activity results information can include information on the number of logins by the participants over a predetermined period and the number of redemptions by the participants over a predetermined period.

The partner administrator can drill-down or navigate through the partner administrator's view to obtain detailed reporting information provided by the dashboard as needed. A news ticker 708 (see FIG. 7) with relevant, current information can scroll on the home page of the partner administrator view 700. In one embodiment, the content of the news ticker 708 is customizable by the partner administrator and can be scrolled through by the partner administrator if there multiple news items. The partner administrator can be notified by the platform through the news ticker 708 that new promotions have been made available to them by manufacturers. The manufacturer administrator can add items to the news ticker by creating news items and they will be visible by all partner companies. The partner administrator can view all new promotions and review the details of each promotion from the partner administrator view. The partner administrator can either decline or accept the terms and conditions of each new promotion. If the partner administrator declines to participate in an offered rewards program, the partner administrator can provide a reason for declining the promotion to complete the decline process.

Once a promotion is accepted by the partner administrator, the partner administrator can modify the partner's participation in the promotion based on pre-set limitations of the manufacturer. In one embodiment, the partner administrator can add additional reward points or activities or transactions to the manufacturer-provided promotion or reward program. In addition, the partner administrator can determine whether the partner will participate as an organization (company-level), teams (role-based), or as individuals (representative-level) within the company. If the partner is participating as an organization or a team, the partner administrator must also determine how any earned reward points will be allocated, i.e., the points can be allocated to the organization or team(s) and/or the points can be allocated to the individuals. All non-manufacturer-provided modifications to a reward program are separate from the manufacturer reward program and can be separately tracked and paid by the partner. Once modifications to the promotion or rewards program are processed and approved, the promotion can be activated and launched within the partner organization to the appropriate teams and/or participants.

Partner administrators may also use the platform/system to create promotions or programs specifically to recognize and reward teams and individuals within their organization. Unlike manufacturer-provided promotions, management and funding of the promotion or program modifications and/or new promotions or programs by partners is entirely the responsibility of the partner organization. Any promotions created by the partner, whether a new promotion or a modification to manufacturer promotion, are available only to the teams or individuals of the partner.

FIG. 4 shows an exemplary embodiment of a process for a partner to manage rewards for a promotion or reward program. The process begins with a partner administrator or manager creating a promotion for the partner's employees or participants (step 402) using the platform. When creating the promotion with the platform, the partner manager can do one or more of the following: create or select (from predetermined options) a name for the promotion; provide a general description of the promotion; create or select (from predetermined options) the terms and conditions for the promotion that will control how the promotion is executed and applied to participants; select the period of time that the promotion will be active or available, including the providing of start and end times and dates; create or select (from predetermined options) a graphical banner for the promotion; determine if a grace period for promotion claims will be provided; define the activities, including base (required) activities and optional activities, associated with the promotion to be completed to earn rewards (or points); and assign rewards (or points) to those required and optional activities and transactions. When using the platform, the partner manager can manually enter information into the platform to provide information on the promotion, or the partner manager can select a parameter for the promotion from one or more available preselected options provided by the platform. The available preselected options can be incorporated or stored in the platform and/or can be provided based on entries used for previous promotions.

After the partner manager has created the promotion, the partner manager can select the participants to participate in the promotion (step 404). The participants can be group, team and/or individually based or selected. After the participants have been selected, a determination is made as to whether any teams (or groups) have been selected as participants (step 406). If any teams (or groups) have been selected, the rewards (or points) have to be assigned or distributed to the team members (step 408). The distribution of rewards (or points) to the team members can be: 1) distributed equally among team members; 2) provided to a team account that can be accessed by individuals (account signers) who have access to spend from the team account; and 3) manually assigned distribution percentages to individual team members.

After the partner manager has assigned or distributed the points to the team members, or if no teams were selected as participants, the participants or partner managers can submit completed activities for the promotion to the platform (step 410). The completed activities can be submitted by: user entry and reconciled; system integration; or by flat file data feed. As completed activities are submitted, a determination is made using the platform as to whether the completed activities have been approved (step 412). The approval process is an optional step that is not required for all promotions. If required, the approval process involves the partner manager making a determination that the submitted activity has been completed in the proper manner. In one embodiment, the platform itself can make the decision using a set of decision rules. If the activities are not approved, the process returns to step 410 to give the participants an opportunity to edit or reenter the information associated with the activity to see if it can be approved. In another embodiment, the participants cannot resubmit activity information and can only submit information on newly completed activities.

After the promotion activities are approved or if no approval is required, the corresponding rewards (or points) are provided to the participants for the completed activities (step 414). The provided rewards can be “paid for” out of a partner account. The distribution can be: to the individuals who made the completed activity submissions; in accordance with team distribution rules; or by the partner manager. In another embodiment, the process can return to step 410 to give the participants additional opportunities to submit completed activities for approval. In one embodiment, the approval and rewards distribution steps can be completed each time an activity is submitted. In another embodiment, the approval and reward distribution steps can be completed one time after all completed activities have been submitted.

When a promotion or reward program is launched into the partner organization at the individual, participant or representative-level, a separate, individual participant view is provided to the individuals or participants to track their participation and performance in promotions, both manufacturer-sponsored and internal partner-sponsored. As shown in FIG. 8, the individual participant's view or user interface 800 can provide the individual participants for each partner access to dashboard reporting that presents a summary of the user's performance 802, the user's promotions 804, the user's submitted claims for the corresponding promotions 806, and the user's wishlist of items to redeem 808. For example, the performance summary information can include information on the number of promotions participated in by the user, the total number of points earned by the user, the number of redemptions by the user and the total number of points redeemed by the user; the user's claim information can include the number of user claims accepted, the number of user claims pending review and the number of user claims rejected, and the user's wishlist information can include information on the item to be redeemed, the number of points to redeem the item, and the number of times the user has redeemed the item. News tickers 810 can be utilized to keep the participant current on new and relevant information. In one exemplary embodiment, a participant can receive an electronic communication, e.g., email or text message, informing them that there has been a change to the information on the news ticker. Dashboards can be utilized to provide information regarding: promotions that the participant is actively participating in, individual participant performance compared to peers, the leading participant or representative, the number of rewards (or points) earned, the number of rewards (or points) redeemed; and the items purchased through rewards (or points) redemption.

In an exemplary embodiment, if required by the structure or requirements of a promotion, a participant or representative may have to provide certain information as well as proof of performance of the activity to “claim” the corresponding rewards (or points). In one exemplary embodiment, the representative or participant may submit their performance claims through the platform by entering performance data in online forms as well as by uploading files, e.g., invoice files, as proof of performance to accumulate rewards (or points). FIG. 9 shows an exemplary embodiment of a user interface 900 for a participant to enter information about the participant's completed activities. The participant can use user interface 900 to select an activity for a promotion, enter the number of times the participant has completed the activity and submit the supporting information to demonstrate that the participant has actually completed the activity. FIG. 10 shows an exemplary embodiment of an approval interface 1000 for a partner administrator and manufacturer administrator to approve the submitted activities of the participants.

Rewards (or points) may be redeemed by participants for items in an integrated rewards catalog that includes items such as travel vouchers, electronic gift-certificates, gift cards, merchandise, etc. Representatives or participants may browse the rewards catalog and select their items for redemption as well as flag items to place on a personal wishlist. In one embodiment, online shopping cart technology can be utilized to fulfill this functionality. FIG. 11 shows an exemplary embodiment of a user interface 1100 for a participant to access the reward catalog (not shown).

FIG. 5 shows an exemplary embodiment of a process for a participant to redeem rewards from the reward program. The process begins with a participant reviewing the items that can be redeemed with the rewards (or points) that the participant earned (step 502) from completing designated tasks from one or more promotions or reward programs as described with respect to FIGS. 3 and 4. The participant can browse or review items in the platform based on category, brand, price or keyword search. In one exemplary embodiment, the items to be redeemed can be filtered by location and/or by partner and/or manufacturer. If the participant has identified an item(s) of interest, the participant can select that item(s) for redemption (step 504). In one embodiment, the participant can add the item(s) to an electronic cart.

After the participant has selected an item(s) for redemption, the participant can start the process of redeeming the item(s) (step 506). If needed, the participant can provide additional information to redeem certain selected item(s) (step 508). The participant can then finalize the participant's order (step 510) and the corresponding rewards (or points) are deducted from the participant's account (step 512). In one exemplary embodiment, a participant can purchase additional rewards (or points) to obtain enough rewards (or points) to redeem a desired item. Once the order has been submitted and “paid for,” the platform can assign the order to the proper order queue. In one exemplary embodiment, there can be different order queues depending on the items ordered. For example, there can be order queues for: digital certificates that are fulfilled by email, gift cards that are fulfilled by a gift card fulfillment service, and manufacturer or vendor fulfilled items that are fulfilled via purchase order sent to the manufacturer or vendor using FTP (file transfer protocol) or by email.

In one exemplary embodiment, a report generator can be built into each view of the platform or system so information can be selected, filtered and stored to create standard reports for users of the platform or system. FIG. 12 shows an exemplary embodiment of user interface 1200 for a manufacturer administrator to generate reports regarding the promotions of the manufacturer. FIGS. 13-15 show embodiments of a registered user report, a redemptions by day report and participant claim summary report generated from user interface 1200.

Embodiments within the scope of the present application include program products having machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Likewise, software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Other substitutions, modifications, changes and omissions may be made in the design, operating conditions and arrangement of the exemplary embodiments without departing from the scope of the present application. Accordingly, the present application is not limited to a particular embodiment, but extends to various modifications that nevertheless fall within the scope of the appended claims. It should also be understood that the phraseology and terminology employed herein is for the purpose of description only and should not be regarded as limiting.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., ranges, sequences, enumerations, frequencies, durations, etc.), mounting arrangements, use of materials, orientations, data formats, implementation platforms, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, manufacture, and implementation for those of ordinary skill having the benefit of this disclosure, without undue experimentation.

What is claimed is:

1. A computer implemented method of managing rewards associated with a plurality of promotions, the method comprising:
creating a promotion by a manufacturer using a computer-based platform, the promotion having at least one activity to be completed to receive a reward;
sending an invitation over a computer network to at least one partner to participate in the created promotion using the computer-based platform, the at least one partner not being affiliated with the manufacturer creating the promotion;
accepting the invitation to participate in the created promotion by the at least one partner using the computer-based platform;
modifying the accepted promotion by the at least one partner using the computer-based platform to add at least one additional activity or at least one additional reward;
selecting, by the at least one partner, at least one participant to participate in the modified promotion using the computer-based platform;
completing, by the selected at least one participant, at least one activity associated with the modified promotion;
entering information on the completed at least one activity into the computer-based platform by the selected at least one participant;
providing the reward to the selected at least one participant using the computer-based platform in response to the selected at least one participant entering the information on the completed at least one activity; and
redeeming an item from an integrated catalog, by the selected at least one participant, with the provided reward using the computer-based platform.

2. The method of claim 1 further comprising:
creating a second promotion by a second manufacturer using the computer-based platform, the second promotion having at least one second activity to be completed to receive a second reward;
sending an invitation over a computer network to the at least one partner to participate in the created second promotion using the computer-based platform, the at least one partner not being affiliated with the second manufacturer creating the second promotion; and
accepting the invitation to participate in the created second promotion by the at least one partner using the computer-based platform.

3. The method of claim 2 further comprising
selecting, by the at least one partner, the at least one participant to participate in the second promotion using the computer-based platform;
completing, by the selected at least one participant, at least one second activity associated with the second promotion;
entering second information into the computer-based platform on the completed at least one second activity by the selected at least one participant;
providing second rewards to the selected at least one participant using the computer-based platform in response to the selected at least one participant entering the information on the completed at least one second activity; and
totaling the provided rewards and the provided second rewards for the selected at least one participant.

4. The method of claim 1 wherein:
said sending an invitation over a computer network includes sending an invitation over the computer network to a plurality of partners to participate in the created promotion using the computer-based platform, the plurality of partners not being affiliated with the manufacturer creating the promotion; and
said accepting the invitation to participate in the created promotion includes accepting the invitation by more than one partner of the plurality of partners using the computer-based platform.

5. The method of claim 1 wherein said creating a promotion by a manufacturer includes at least one of:
selecting a name for the created promotion;
providing a description of the created promotion;
selecting a set of terms and conditions for the created promotion;
selecting a period of time that the created promotion is active;
selecting a graphical banner to be associated with the created promotion;
determining if a grace period for promotion claims is provided;
defining the at least one activity to be completed; and
assigning a reward amount to the defined at least one activity.

6. The method of claim 5 wherein said defining the at least one activity includes defining at least one required activity and at least one optional activity.

7. The method of claim 1 wherein said modifying the accepted promotion by the at least one partner includes:
defining at least one additional activity to be completed; and
assigning an additional reward amount to the defined at least one additional activity.

8. The method of claim 1 wherein said modifying the accepted promotion by the at least one partner includes assigning an additional reward amount to the at least one activity.

9. The method of claim 1 wherein said providing the reward to the selected at least one participant includes reviewing and approving the entered information prior to providing the reward.

10. The method of claim 1 further comprises:
creating a second promotion by the at least one partner using the computer-based platform, the second promotion having at least one second activity to be completed to receive a second reward;
selecting the at least one participant to participate in the second promotion by the at least one partner using the computer-based platform;
completing, by the selected at least one participant, at least one second activity associated with the second promotion;
entering information on the completed at least one second activity into the computer-based platform by the selected at least one participant;
providing the second reward to the selected at least one participant using the computer-based platform in response to the entered information on the completed at least one second activity; and
totaling the provided reward and the provided second reward for the selected at least one participant.

11. The method of claim 1 wherein said selecting, by the at least one partner, at least one participant includes selecting at least one team and at least one individual by the at least one partner, the at least one team includes a plurality of individuals.

12. The method of claim 12 wherein said selecting, by the at least one partner, at least one participant further includes distributing the reward for the at least one team to the plurality of individuals of the at least one team.

13. A system to manage rewards associated with a plurality of promotions, the system comprising:
a first computing device, the first computing device comprising a memory device to store a rewards platform and a microprocessor to execute the rewards platform;
a second computing device, the second computing device being operated by a manufacturer, the second computing device communicating with the first computing device over the computer network, the manufacturer accessing the rewards platform on the first computing device to create a reward program, the reward program having at least one activity to be completed and a reward to be provided upon completion of the at least one activity;
a third computing device, the third computing device being operated by a partner, the third computing device communicating with the first computing device over the computer network, the partner receiving an invitation from the reward program on the third computing device to participate in the created rewards program from the manufacturer, the partner accessing the rewards platform on the first computing device with the third computing device to accept the invitation to participate in the created rewards program; and
a fourth computing device, the fourth computing device being operated by a participant, the fourth computing device communicating with the first computing device over the computer network, the participant receiving an invitation from the reward program on the fourth computing device to participate in the accepted rewards program by the partner, the participant accessing the rewards platform on the first computing device with the fourth computing device to accept the invitation to participate in the accepted rewards program.

14. The system of claim 13 wherein the rewards platform comprises a user interface displayed on the third computing device, the user interface being operable to permit the partner to modify the created rewards program to add at least one of an additional activity or an additional reward.

15. The system of claim 13 wherein the rewards platform comprises a user interface displayed on the fourth computing device, the user interface being operable to permit the participant to enter information relating to the completion of the at least one activity.

16. The system of claim 13 wherein the rewards platform comprises a user interface displayed on the second computing device, the user interface being operable to permit the manufacturer to invite a second partner to participate in the reward program.

17. The system of claim 13 wherein the rewards platform comprises a user interface displayed on the fourth computing device, the user interface being operable to permit the participant to review an integrated catalog of items for redemption with rewards earned by the participant.

18. The system of claim 13 further comprising an additional second computing device, the additional second computing device being operated by a second manufacturer, the additional second computing device communicating with the first computing device over the computer network, the second manufacturer accessing the rewards platform on the first computing device to create a second reward program, the second reward program having at least one second activity to be completed and a second reward to be provided upon completion of the at least one second activity.

19. The system of claim 18 wherein the rewards platform comprises a user interface displayed on the third computing device, the user interface being operable to permit the partner to accept an invitation to participate in the second reward program created by a second manufacturer.

20. The system of claim 13 wherein the computer network comprises an Internet.
